(19) United States
(12) Patent Application Publication
(10) Pub. No.: US 2010/0295922 A1
(43) Pub. Date: Nov. 25, 2010

(54) Coding Mode Selection For Block-Based Encoding

(76) Inventors: Gene Cheung, Tokyo (JP); Antonio Ortega, Los Angeles, CA (US); Takashi Sakamoto, Tokyo (JP)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/864,204

(22) PCT Filed: Jan. 25, 2008
(86) PCT No.: PCT/US08/52081

§ 371 Date: Jul. 22, 2010

(51) Int. Cl. H04N 7/26; H04N 13/00

(52) U.S. Cl. 348/42; 375/240.02; 348/E13.001; 375/E07.126

(57) ABSTRACT

In a method of selecting coding modes for block-based encoding of a digital video stream composed of a plurality of successive frames, depth values of pixels contained in coding blocks having different sizes in the plurality of successive frames are obtained, the largest coding block sizes that contain pixels having sufficiently similar depth values are identified, and coding modes for block-based encoding of the coding blocks having, at minimum, the largest identified coding block sizes are selected.

### BACKGROUND

Digital video streams are typically transmitted over a wired or wireless connection as successive frames of separate images. Each of the successive images or frames typically comprises a substantial amount of data, and therefore, the stream of digital images often requires a relatively large amount of bandwidth. As such, a great deal of time is often required to receive digital video streams, which is bothersome when attempting to receive and view the digital video streams.

Efforts to overcome problems associated with transmission and receipt of digital video streams have resulted in a number of techniques to compress the digital video streams. Although other compression techniques have been used to reduce the sizes of the digital images, motion compensation has evolved into perhaps the most useful technique for reducing digital video streams to manageable proportions. In motion compensation, portions of a “current” frame that are the same or nearly the same as portions of previous frames, in different locations due to movement in the frame, are identified during a coding process of the digital video stream. When blocks containing the basically redundant pixels are found in a preceding frame, instead of transmitting the data identifying the pixels in the current frame, a code that tells the decoder where to find the redundant or nearly redundant pixels in the previous frame for those blocks is transmitted.

In motion compensation, therefore, predictive blocks of image samples (pixels) within the digital images that best match a similar-shaped block of samples (pixels) in the current digital image are identified. Identifying the predictive blocks of image samples is a highly computationally intensive process and its complexity has been further exacerbated in recent block-based video encoders, such as, ITU-T H.264/ISO MPEG-4 AVC based encoder, because motion estimation is performed using coding blocks having different pixel sizes, such as, 4×4, 4×8, 8×4, 8×8, 8×16, 16×8, and 16×16. More particularly, these types of encoders use a large set of coding modes, each optimized for a specific content feature in a coding block, and thus, selection of an optimized coding mode is relatively complex.

Although recent block-based video encoders have become very coding efficient, resulting in higher visual quality for the same encoding bit-rate compared to previous standards, the encoding complexity of these encoders has also dramatically increased as compared with previous encoders. For applications that require real-time encoding, such as, live-streaming or teleconferencing, this increase in encoding complexity creates implementation concerns.

Conventional techniques aimed at reducing the encoding complexity have attempted to prune unlikely coding modes a priori using pixel domain information. Although some of these conventional techniques have resulted in reducing encoding complexity, they have done so at the expense of increased visual distortion.

An improved approach to reducing encoding complexity while maintaining compression efficiency and quality would therefore be beneficial.

### BRIEF DESCRIPTION OF THE DRAWINGS

Features of the present invention will become apparent to those skilled in the art from the following description with reference to the figures, in which:

FIG. 1 depicts a simplified block diagram of a system for block-based encoding of a digital video stream, according to an embodiment of the invention;

FIG. 2 shows a flow diagram of a method of selecting coding modes for block-based encoding of a digital video stream, according to an embodiment of the invention;

FIG. 3 depicts a diagram of a two-dimensional frame that has been divided into a plurality of coding blocks, according to an embodiment of the invention;

FIG. 4 shows a flow diagram of a method of pre-pruning multiple-sized coding blocks based upon depth values of the multiple-sized coding blocks, according to an embodiment of the invention;

FIG. 5 shows a diagram of a projection plane depicting two objects having differing depth values, according to an embodiment of the invention; and

FIG. 6 shows a block diagram of a computing apparatus configured to implement or execute the methods depicted in FIGS. 2 and 4, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a method and a system for selecting coding modes for block-based encoding of a digital video stream. Also disclosed herein is a video encoder configured to perform the disclosed method. According to one aspect, the frames of the digital video stream are divided into multiple-sized coding blocks formed of pixels, and depth values of the pixels are used in quickly and efficiently identifying the largest coding blocks that contain sufficiently similar depth values. More particularly, similarities of the depth values, which may be defined as the distances between a virtual camera and rendered pixels in a frame, of the same-sized coding blocks are evaluated to determine whether the same coding mode may be used on the same-sized coding blocks.

Generally speaking, regions of similar depth in a frame are more likely to correspond to regions of uniform motion. In addition, the depth value information is typically generated by a graphics rendering engine during the rendering of a 3D scene to a 2D frame, and is thus readily available to a video encoder. As such, if the readily available depth value information is indicative of uniform motion in a spatial region, consideration of smaller block-sizes for motion estimation may substantially be avoided, leading to a reduction in complexity in mode selection along with a small coding performance penalty.

The method and system disclosed herein may therefore be implemented to compress video for storage or transmission and for subsequent reconstruction of an approximation of the original video. More particularly, the method and system disclosed herein relates to the coding of video signals for compression and subsequent reconstruction. In one example, the method and system disclosed herein may be implemented to encode video for improved online game viewing.

Through implementation of the method, system, and video encoder disclosed herein, the complexity associated with block-based encoding may significantly be reduced with negligible increase in visual distortion.

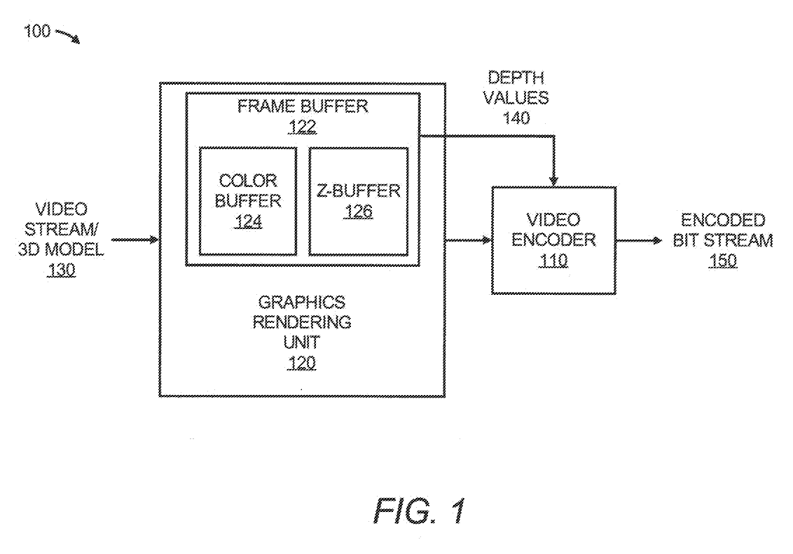

With reference first to FIG. 1, there is shown a simplified block diagram of system 100 for block-based encoding of a digital video stream, according to an example. In one regard, the various methods and systems disclosed herein may be implemented in the system 100 depicted in FIG. 1 as discussed in greater detail herein below. It should be understood that the system 100 may include additional components and that some of the components described herein may be removed and/or modified without departing from a scope of the system 100.

As shown in FIG. 1, the system 100 includes a video encoder 110 and a graphics rendering unit 120. The graphics rendering unit 120 is also depicted as including a frame buffer 122 having a color buffer 124 and a z-buffer 126. Generally speaking, the video encoder 110 is configured to perform a process of quickly and efficiently selecting optimized coding modes for block-based encoding of a digital video stream 130 based upon depth value information 140 obtained from the graphics rendering unit 120. The video encoder 110 may apply the optimized coding modes in performing a block-based encoding process on the video stream 130.

The graphics rendering unit 120 receives a video stream containing a three-dimensional (3D) model 130 from an input source, such as, a game server or other type of computer source. The graphics rendering unit 120 is also configured to render, or rasterize, the 3D model 130 onto a two-dimensional (2D) plane, generating raw 2D frames. According to an example, the rendering of the 3D model 130 is performed in the frame buffer 122 of the graphics rendering unit 120.

The graphics rendering unit 120 individually draws virtual objects in the 3D model 130 onto the frame buffer 122, during which process, the graphics rendering unit 120 generates depth values for the drawn virtual objects. The color buffer 124 contains the RGB values of the drawn virtual objects in pixel granularity and the z-buffer 126 contains the depth values of the drawn virtual objects in pixel granularity. The depth values generally correspond to the distance between rendered pixels of the drawn virtual objects and a virtual camera typically used to determine object occlusion during a graphics rendering process. Thus, for instance, the depth values of the drawn virtual objects (or pixels) are used for discerning which objects are closer to the virtual camera, and hence which objects (or pixels) are occluded and which are not. In one regard, the graphics rendering unit 120 is configured to create depth maps of the 2D frames to be coded by the video encoder 110.

The video encoder 110 employs the depth values 140 of the pixels in quickly and efficiently selecting substantially optimized coding modes for block-based encoding of the video stream 130. More particularly, for instance, the video encoder 110 is configured to quickly and efficiently select the coding modes by evaluating depth values 140 of pixels in subsets of macroblocks (16×16 pixels) and quickly eliminating unlikely block sizes from a candidate set of coding blocks to be encoded. Various methods the video encoder 110 employs in selecting the coding modes are described in greater detail herein below.

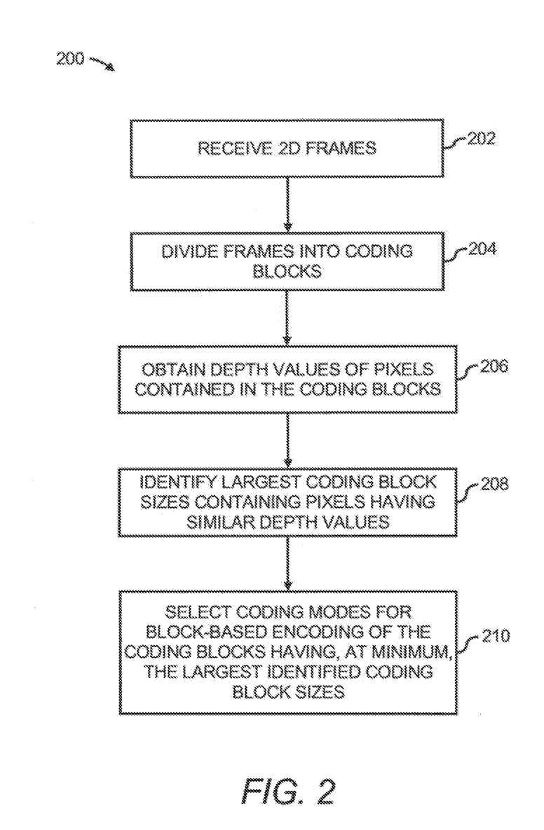

With reference now to FIG. 2, there is shown a flow diagram of a method 200 of selecting coding modes for block-based encoding of a digital video stream, according to an embodiment. It should be apparent to those of ordinary skill in the art that the method 200 depicted in FIG. 2 represents a generalized illustration and that other steps may be added or existing steps may be removed, modified or rearranged without departing from a scope of the method 200.

Generally speaking, the video encoder 110 may include at least one of hardware and software configured to implement the method 200 as part of an operation to encode the video stream 130 and form the encoded bit stream 150. In addition, the video encoder 110 may implement the method 200 to substantially reduce the complexity in block-based encoding of the video stream 130 by quickly and efficiently identifying substantially optimized coding modes for the coding blocks. As such, for instance, by implementing the method 200, the complexity of real-time block-based encoding, such as, under the H.264 standard, may substantially be reduced.

At step 202, the video encoder 110 may receive the rendered 2D frames from the graphics rendering unit 120. The 2D frames may have been rendered by the graphics rendering unit 120 as discussed above.

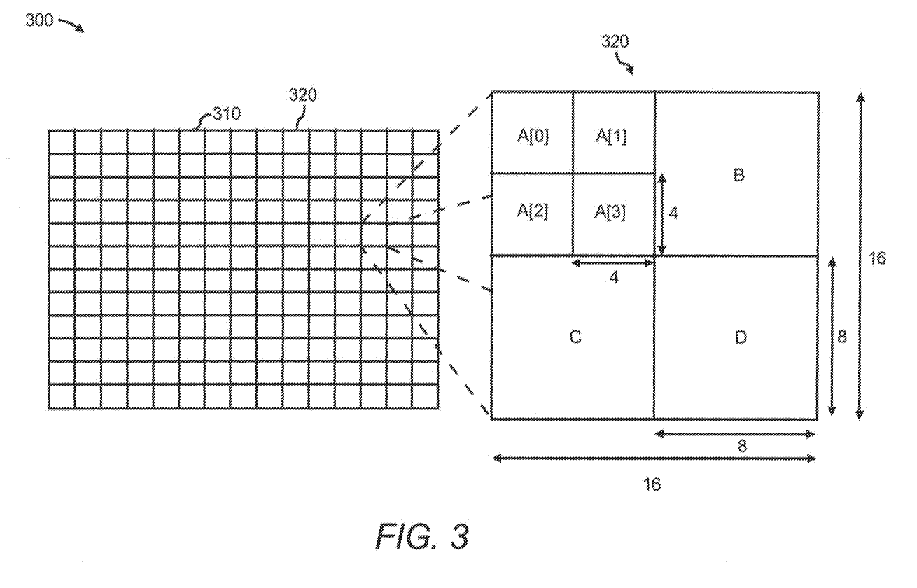

At step 204, the video encoder 110 divides each of the 2D frames into coding blocks 320 having different available sizes, as shown, for instance, in FIG. 3. FIG. 3, more particularly, depicts a diagram 300 of a 2D frame 310 that has been divided into a plurality of coding blocks 320. As shown therein, the video encoder 110 may divide the 2D frame 310 into coding blocks 320 having a first size, such as, 16×16 pixels, otherwise known as macroblocks. Also depicted in FIG. 3 is an enlarged diagram of one of the coding blocks 320, which shows that the video encoder 110 may further divide the coding blocks 320 into smaller coding blocks A-D.

More particularly, FIG. 3 shows that the 16×16 pixel coding blocks 320 may be divided into coding blocks A-D having second sizes, such as, 8×8 pixels. FIG. 3 also shows that the second-sized coding blocks A-D may be further divided into coding blocks A[0]-A[3] having third sizes, such as, 4×4 pixels. As such, the second-sized coding blocks A-D are approximately one-quarter the size of the first-sized coding blocks and the third-sized coding blocks A[0]-A[3] are approximately one-quarter the size of the second-sized coding blocks A-D. Although not shown, the second-sized coding blocks B-D may also be divided into respective third-sized coding blocks B[0]-B[3], C[0]-C[3], and D[0]-D[3], similarly to the second-sized coding block A.

At step 206, the video encoder 110 obtains the depth values 140 of the pixels contained in the coding blocks 320, for instance, from the graphics rendering unit 120. As discussed above, the video encoder 110 may also receive the depth values 140 of the pixels mapped to the 2D frames.

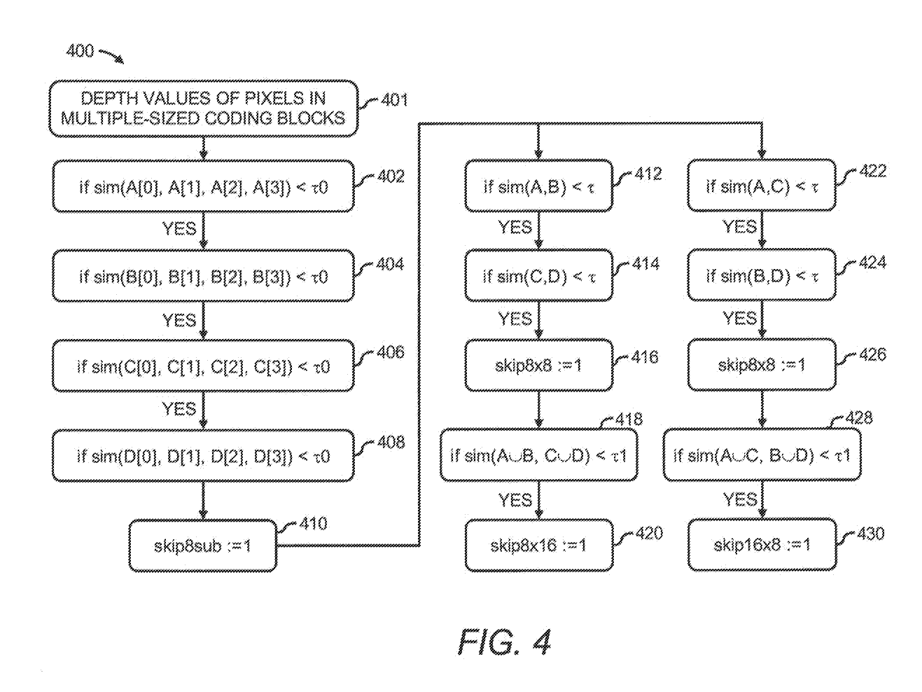

At step 208, the video encoder 110 identifies the largest coding block sizes containing pixels having sufficiently similar depth values 150 in each of the macroblocks 320, for instance, in each of the 16×16 pixel coding blocks. Step 208 is discussed in greater detail herein below with respect to the method 400 depicted in FIG. 4.

At step 210, the video encoder 110 selects coding modes for block-based encoding of the coding blocks 320 having, at minimum, the largest coding block sizes identified has containing pixels having sufficiently similar depth values. More particularly, the video encoder 110 selects substantially optimized coding modes for coding blocks 320 having at least the identified largest coding block sizes. The video encoder 110 may then perform a block-based encoding operation on the coding blocks 320 according to the selected coding modes to output an encoded bit stream 150.

Turning now to FIG. 4, there is shown a flow diagram of a method 400 of pre-pruning multiple-sized coding blocks based upon depth values 140 of the multiple-sized coding blocks, according to an embodiment. It should be apparent to those of ordinary skill in the art that the method 400 depicted in FIG. 4 represents a generalized illustration and that other steps may be added or existing steps may be removed, modified or rearranged without departing from a scope of the method.

Generally speaking, the method 400 is a more detailed description of step 206 in FIG. 2 of identifying the largest coding blocks containing pixels having sufficiently similar depth values 140. More particularly, the method 400 includes steps for quickly and efficiently pre-pruning multiple-sized coding blocks having dissimilar depth values. In other words, those multiple-sized coding blocks in each of the macroblocks 320 having dissimilar depth values 140 are removed from a candidate set of coding blocks for which coding modes are to be selected. The candidate set of coding blocks may be defined as including those coding blocks of various sizes for which substantially optimized coding modes are to be identified. The coding modes include, for instance, Skip, Intra, and Inter.

According to an example, the video encoder 110 employs the depth values 140 of pixels available in the Z-buffer of the graphics rendering unit 120 in identifying the substantially optimized coding modes. In a Z-buffer, a depth value for each pixel is represented by a finite N-bit representation, with N typically ranging from 16 to 32 bits. Because of this finite precision limitation, and set of true depth values z, Z-buffers commonly use quantized depth values z_{b} of N-bit precision:

$$\begin{matrix}{z}_{b} = {2}^{N} ( a + \frac{b}{z} ) , where , & Equation ( 1 ) \\ a = \frac{zF}{zF - zN} and b = \frac{zF \cdot zN}{zN - zF} . & Equation ( 2 )\end{matrix}$$

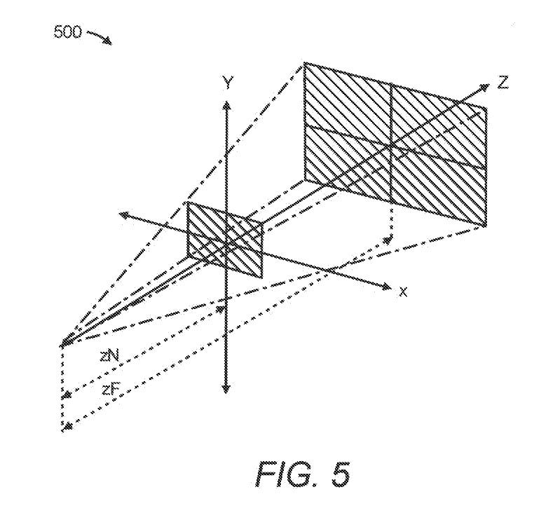

In Equation (2), zN and zF are the z-coordinates of the near and far planes as shown in the diagram 500 in FIG. 5. As shown therein, the near plane is the projection plane, while the far plane is the furthest horizon from which objects would be visible; zN and zF are typically selected to avoid erroneous object occlusion due to rounding of a true depth z to a quantized depth z_{b}. Equation (1) basically indicates that depth values are quantized non-uniformly. That is, objects close to the virtual camera have finer depth precision than objects that are far away, which is what is desired in most rendering scenarios. The normalized quantized depth value may also be defined as:

$${z}_{0} = \frac{{z}_{b}}{{2}^{N}} , where {z}_{0} ∈ [ 0 , 1 ] . \qquad Equation ( 3 )$$

Either the scaled integer version z_{b} or the normalized version z₀ of the quantized depth value may be obtained from a conventional graphics card. In addition, as z approaches zF (resp. zN), z₀ approaches 1 (resp. 0) and since zF>>zN,

a≈1 and b≦−zN, and therefore, Equation (4)

$$z = \frac{zN}{( 1 - {z}_{0} )} . \qquad Equation ( 5 )$$

Accordingly, an absolute value metric (z′−z) or a relative value metric (d/z=d′/z′ or d′/d=1+δz/z), where d and d′ denote the real distances corresponding to one pixel distance for a first block and a second block at depths z and z′, may be used to identify discontinuities between the first block having the first depth z and the second block having the second depth z′.

The method 400 is implemented on each of the first sized blocks (macroblocks 320 in FIG. 3) to identify the largest of the differently sized blocks that have sufficiently similar depth values. More particularly, for instance, the coding blocks are evaluated from the smallest sized blocks to the largest sized blocks in order to identify the largest sized blocks having the sufficiently similar depth values. In doing so, the smaller blocks within the first sized blocks 320 having sufficiently similar depth values may be removed from the candidate set, such that, coding modes for the larger blocks may be identified. In one regard, therefore, the complexity and time required to identify the coding blocks 320 may substantially be reduced as compared with conventional video encoding techniques.

As indicated at reference numeral 401, the video encoder 110 is configured to implement the method 400 based upon the depth values of the pixels communicated from the z-buffer 126 of the graphics rendering unit 120.

At step 402, the video encoder 110 compares the depth values of four of the third-sized blocks A[0]-A[3], for instance, blocks having 4×4 pixels, in a second-sized block A, for instance, a block having 8×8 pixels. The video encoder 110, more particularly, performs the comparison by applying a similarity function sim( ) to the four third-sized blocks A[0]-A[3]. The similarity function sim( ) is described in greater detail herein below.

If the depth values of the four third-sized blocks A[0]-A[3] in the second-sized block A are sufficiently similar, that is, if a deviation of the depth values is less than a predefined level (<τ₀), the third-sized blocks A[0]-A[3] in the second-sized block A are removed from the candidate set of coding blocks (skip8sub:=1). As such, for instance, if the third-sized blocks A[0]-A[3] are determined to be sufficiently similar, that is sim(A[0], A[1], A[2], A[3])<τ₀, the same coding mode may be employed in encoding those blocks and thus, coding modes for each of the third-sized blocks A[0]-A[3] need not be determined.

However, if the depth value of any of the third-sized blocks A[0]-A[3] deviates from another third-sized block A[0]-A[3] beyond the predefined level (<τ₀), the third-sized blocks are included in the candidate set. In other words, these third-sized blocks A[0]-A[3] may be evaluated separately in determining which coding mode to apply to the third-sized blocks A[0]-A[3].

Similarly to step 402, the depth values of the third-sized blocks B[0]-B[3], C[0]-C[3], and D[0]-D[3] are respectively compared to each other to determine whether the third-sized blocks should be included in the candidate set at steps 404-408.

If it is determined that the depth values of each of the sets of third-sized blocks A[0]-A[3], B[0]-B[3], C[0]-C[3], and D[0]-D[3] are respectively sufficiently similar, then all of the block sizes that are smaller than the second size are removed from the candidate set (skip8sub:=1), as indicated at step 410. In instances where at least one of the sets of third-sized blocks A[0]-A[3], B[0]-B[3], C[0]-C[3], and D[0]-D[3] is not respectively sufficiently similar, then those sets are included in the candidate set and coding modes for those sets may be determined separately from each other.

In addition, the video encoder 110 compares the depth values of those second-sized blocks A-D having third-sized blocks A[0]-A[3], B[0]-B[3], C[0]-C[3], and D[0]-D[3] that have been removed from the candidate set, in two parallel tracks. More particularly, the video encoder 110 performs the comparison by applying a similarity function sim( ) to adjacent sets of the second-sized blocks A-D. In this regard, at step 412, the video encoder 110 applies the similarity function to two horizontally adjacent second-sized blocks A and B, and, at step 414, the video encoder 110 applies the similarity function to two horizontally adjacent second-sized blocks C and D.

Likewise, at step 422, the video encoder 110 applies the similarity function to the depth values of two vertically adjacent second-sized blocks A and C, and, at step 424, the video encoder 110 applies the similarity function to the depth values of two vertically adjacent second-sized blocks B and D.

More particularly, the video encoder 110 determines whether the depth values of the two horizontally adjacent second-sized blocks A and B are sufficiently similar and/or if the depth values of the other two horizontally adjacent second-sized blocks C and D are sufficiently similar, that is, whether a deviation of the depth values between blocks A and B and between blocks C and D are less than a predefined level (<τ). Likewise, the video encoder 110 determines whether the depth values of the two vertically adjacent second-sized blocks A and C are sufficiently similar and/or if the depth values of the other two vertically adjacent second-sized blocks B and D are sufficiently similar, that is, whether a deviation of the depth values between blocks A and C and between blocks B and D are less than the predefined level (<τ).

If the video encoder 110 determines that the depth values of the two horizontally adjacent second-sized blocks A and B are sufficiently similar, the video encoder 110 removes those second-sized blocks A and B from the candidate set. Likewise, if the video encoder 110 determines that the depth values of the other two horizontally adjacent second-sized blocks C and D are sufficiently similar, the video encoder 110 removes those second-sized blocks C and D from the candidate set. In this instance, the coding blocks 320 having the second-size are removed from the candidate set at step 416 (skip8×8:=1). At this point, the candidate set may include those coding blocks having sizes larger than the second-size, such as, the first-sized blocks 320 and blocks having rectangular shapes whose length or width exceeds the length or width of the second-sized blocks.

In addition, or alternatively, if the video encoder 110 determines that the depth values of the two vertically adjacent second-sized blocks A and C are sufficiently similar, the video encoder 110 removes those second-sized blocks A and C from the candidate set. Likewise, if the video encoder 110 determines that the depth values of the other two vertically adjacent second-sized blocks B and D are sufficiently similar, the video encoder 110 removes those second-sized blocks B and D from the candidate set. In this instance, the coding blocks 320 having the second-size are removed from the candidate set at step 426 (skip8×8:=1).

At step 418, the video encoder 110 compares the depth values of two horizontally adjacent blocks A and B, for instance, having a combined 8×16 pixel size, with the depth values of the other two horizontally adjacent blocks C and D, for instance, having a combined 8×16 pixel size, to determine whether a difference between the depth values exceeds a predefined level (τ₁). Again, the video encoder 110 may use a similarity function sim( ) to make this determination. If the video encoder 110 determines that the depth values of the two horizontally adjacent second-sized blocks A and B are sufficiently similar to the other two horizontally adjacent second-sized blocks C and D, the video encoder 110 removes the second-sized blocks A-D from the candidate set at step 420 (skip8×16:=1).

In addition, or alternatively, at step 428, the video encoder 110 compares the depth values of two vertically adjacent blocks A and C, for instance, having a combined 16×8 pixel size, with the depth values of the other two vertically adjacent blocks B and D, for instance, having a combined 16×8 pixel size, to determine whether a difference between the depth values exceeds the predefined level (τ₁). Again, the video encoder 110 may use a similarity function sim( ) to make this determination. If the video encoder 110 determines that the depth values of the two vertically adjacent second-sized blocks A and C are sufficiently similar to the other two horizontally adjacent second-sized blocks B and D, the video encoder 110 removes the second-sized blocks A-D from the candidate set at step 430 (skip16×8:=1).

According to an example, the first-sized coding blocks 320 having the largest sizes, such as, 16×16 pixels, may not be removed from the candidate set because they contain only one motion vector and are thus associated with relatively low coding costs. In addition, the predefined levels (τ₀, τ, τ₁) discussed above may be selected to meet a desired reduction in the encoding complexity and may thus be determined through experimentation.

Various examples of how the similarity function sim( ) may be defined will now be discussed in order of relatively increasing complexity. In one regard, the selected similarity function sim( ) directly affects the complexity and the performance of the method 400.

In a first example, the maximum and minimum values of the normalized quantized depth values z₀ from the Z-buffer in a given coding block 320 is identified. Based upon Equation (3) above, the normalized quantized depth values z₀ are known to be monotonically decreasing in depth values z, so that the maximum value in z₀ corresponds to the minimum value in z and that the minimum value in z₀ corresponds to the maximum value in z. The similarity of a coding block may then be defined by applying either an absolute value or a relative value metric using the maximum and minimum values of z₀. More particularly, given two coding blocks A and B, the following may be computed:

$$\begin{matrix}{z}_{min} ( A ) = \frac{zN}{1 - {max}_{{z}_{o} ∈ A} ( {z}_{0} )} , & Equation ( 6 ) \\ {z}_{max} ( A ) = \frac{zN}{1 - {min}_{{z}_{o} ∈ A} ( {z}_{o} )} , & Equation ( 7 ) \\ sim ( A , B ) = {z}_{max} ( A ⋃ B ) - {z}_{min} ( A ⋃ B ) , or & Equation ( 8 ) \\ \frac{{z}_{max} ( A ⋃ B ) - {z}_{min} ( A ⋃ B )}{{z}_{max} ( A ⋃ B ) + {z}_{min} ( A ⋃ B )} . & Equation ( 9 )\end{matrix}$$

Given four blocks A, B, C, and D, sim(A,B,C,D) may similarly be defined as follows:

$$\begin{matrix}sim ( A , B ) = {z}_{max} ( A ⋃ … ⋃ D ) - {z}_{min} ( A ⋃ … ⋃ D ) or & Equation ( 10 ) \\ \frac{{z}_{max} ( A ⋃ … ⋃ D ) - {z}_{min} ( A ⋃ … ⋃ D )}{{z}_{max} ( A ⋃ … ⋃ D ) + {z}_{min} ( A ⋃ … ⋃ D )} . & Equation ( 11 )\end{matrix}$$

In this example, the predefined levels (τ₀, τ, τ₁) may be equal to each other in the method 400. In addition, any direct conversion from z₀ in the Z-buffer to true depth z is avoided. For instance, considering a computation up to an 8×8 block size in the method 400, the computation cost per pixel (C₁) using the absolute value metric is:

$$\begin{matrix}{C}_{1} = ( 2 * \frac{63}{64} ) * cost ( comp ) + \\ ( 3 * \frac{1}{64} ) * cost ( add ) + ( 2 * \frac{1}{64} ) * cost ( mult ) \\ \approx 2 * cost ( add )\end{matrix} \qquad Equation ( 12 )$$

where cost(comp), cost(add), and cost(mult) denote the estimated costs of comparisons, additions, and multiplication, respectively. The cost(comp) may be considered to be about as complex as cost(add).

In a second example, all of the z₀-values are converted from the Z-buffer to true depth z-values using Equation (5) and the sum of the z-values is computed. The similarity function sim( ) using an absolute value metric is then the largest difference in sums between any two blocks. More particularly, given two blocks A and B, sim(A,B) may be defined as:

$$sim ( A , B ) = \sum ( A ) - \sum ( B ) , \\ \sum ( A ) = {\sum }_{{z}_{o} ∈ A} \frac{zN}{( 1 - {z}_{o} )} . \qquad Equation ( 13 )$$

Similarly, given four blocks, A, B, C, and D, sim(A,B,C,D) is:

sim(A,B,C,D)=max{Σ(B),Σ(c),Σ(D)}−min{Σ(A),Σ(B),Σ(C),Σ(D)} Equation (14)

Because of the different sizes of the cumulated sums, the predefined levels (τ₀, τ, τ₁) used in the method 400 may be scaled as follows:

τ₀=τ/4, τ₁=2τ. Equation (15)

The computational cost per pixel (C₂) in this case is:

$$Equation$$

$$\begin{matrix}{C}_{2} = \frac{5}{64} * cost ( comp ) + ( 1 + \frac{60 + 1}{64} ) * \\ cost ( add ) + 1 * cost ( mult ) \\ \approx 2 * cost ( add ) + 1 * cost ( mult ) .\end{matrix} \qquad ( 16 )$$

In a third example, all of the z₀-values are converted from the Z-buffer to true depth z-values using Equation (5). For each pixel, the Sobel operator, which is commonly used to detect edges in images, is applied in the depth domain, for instance, to detect singular objects having complex texture. The Sobel operator involves the following equations:

dx_{i,j}=p_{i-1,j+1}2p_{i,j+1}+p_{i+1,j+1}−p_{i-1,j-1}−2p_{i,j-1}+p_{i+1,j-1}, and Equation (17):

dy_{i,j}=p_{i+1,j-1}2p_{i+1,j}+p_{i+1,j+1}−p_{i-1,j-1}−2p_{i,j}−p_{i-1,j+1}, and Equation (18):

Amp(\vec{D}_{i,j})=|dx_{i,j}|+|dy_{i,j}|.

In this example, the similarity function sim( ) is defined as a number of pixels with gradients Amp(\vec{D}_{i,j})'s greater than a pre-set gradient threshold θ.

$$sim ( A , B ) = {\sum }_{( i , j ) ∈ A ⋃ B} 1 ( Amp ( {\vec{D}}_{i , j} ) > θ ) , \qquad Equation ( 20 )$$

where 1(c)=1 if clause c is true, and 1(c)=0 otherwise. Similarly, for four blocks A, B, C, and D, sim(A,B,C,D) is:

$$sim ( A , B , C , D ) = {\sum }_{( i , j ) ∈ A ⋃ B ⋃ C ⋃ D} 1 ( Amp ( {\vec{D}}_{i , j} ) > θ ) . \qquad Equation ( 21 )$$

In this example, the predefined levels (τ₀, τ, τ₁) may be equal to each other in the method 400. In addition, the computational cost per pixel (C₃) for this example may be defined as:

$$\begin{matrix}{C}_{3} = ( 2 + 1 ) * cost ( comp ) + ( 1 + 10 + 1 + \frac{63}{64} ) * \\ cost ( add ) + ( 1 + 4 ) * cost ( mult ) \\ \approx 16 * cost ( add ) + 5 * cost ( mult ) .\end{matrix} \qquad Equation ( 22 )$$

With reference back to FIG. 2, at step 210, the video encoder 110 may implement an existing pixel-based mode selection operation to select the coding modes, such as, for instance, the coding mode selection operation described in Yin, P., et al., “Fast mode decision and motion estimation for JVT/H.264,” IEEE International Conference on Image Processing (Singapore), October 2004, hereinafter the Yin et al. document, the disclosure of which is hereby incorporated by reference in its entirety.

More particularly, the video encoder 110 may set the rate-distortion (RD) costs of the pruned coding block sizes (from step 208) to infinity ∞. The coding mode selection as described in the Yin et al. document is then executed. As discussed above, the pre-pruning operation of the method 400 prunes the smaller coding blocks A[O-A[3], for instance, prior to pruning the larger blocks A-D. As such, the RD costs are set to ∞ successively from smaller blocks to larger blocks and thus, the coding mode selection described in the Yin et al. document will not erroneously eliminate block sizes if the original RD surface is itself not monotonic.

The operations set forth in the methods 200 and 400 may be contained as one or more utilities, programs, or subprograms, in any desired computer accessible or readable medium. In addition, the methods 200 and 400 may be embodied by a computer program, which can exist in a variety of forms both active and inactive. For example, it can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

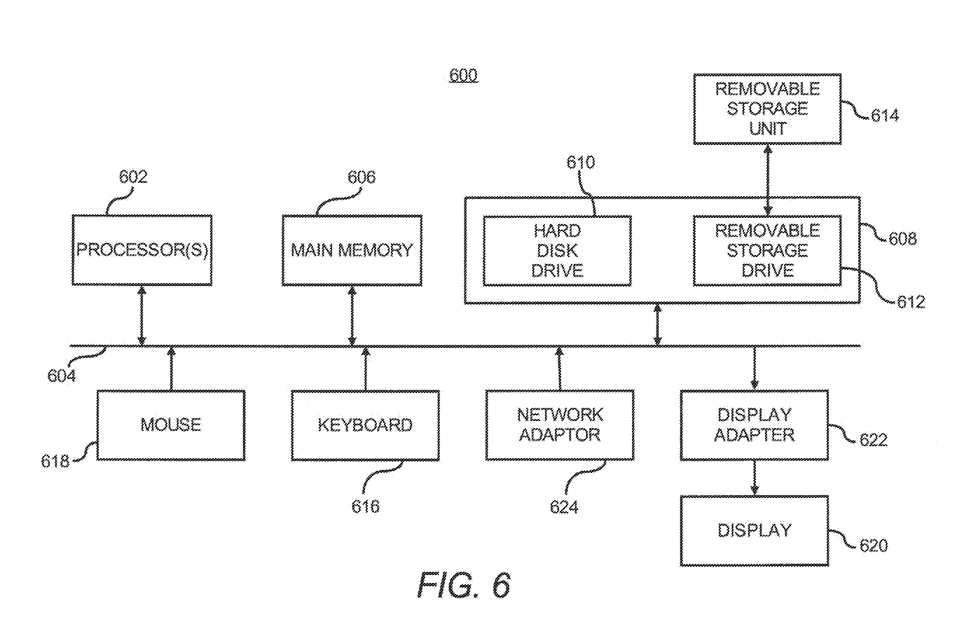

FIG. 6 illustrates a block diagram of a computing apparatus 600 configured to implement or execute the methods 200 and 400 depicted in FIGS. 2 and 4, according to an example. In this respect, the computing apparatus 600 may be used as a platform for executing one or more of the functions described hereinabove with respect to the video encoder 110 depicted in FIG. 1.

The computing apparatus 600 includes a processor 602 that may implement or execute some or all of the steps described in the methods 200 and 400. Commands and data from the processor 602 are communicated over a communication bus 604. The computing apparatus 600 also includes a main memory 606, such as a random access memory (RAM), where the program code for the processor 602, may be executed during runtime, and a secondary memory 608. The secondary memory 608 includes, for example, one or more hard disk drives 610 and/or a removable storage drive 612, representing a floppy diskette drive, a magnetic tape drive, a compact disk drive, etc., where a copy of the program code for the methods 200 and 400 may be stored.

The removable storage drive 610 reads from and/or writes to a removable storage unit 614 in a well-known manner. User input and output devices may include a keyboard 616, a mouse 618, and a display 620. A display adaptor 622 may interface with the communication bus 604 and the display 620 and may receive display data from the processor 602 and convert the display data into display commands for the display 620. In addition, the processor(s) 602 may communicate over a network, for instance, the Internet, LAN, etc., through a network adaptor 624.

It will be apparent to one of ordinary skill in the art that other known electronic components may be added or substituted in the computing apparatus 600. It should also be apparent that one or more of the components depicted in FIG. 6 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A method of selecting coding modes for block-based encoding of a digital video stream, said digital video stream being composed of a plurality of successive frames, said method comprising:
obtaining depth values of pixels contained in coding blocks having different sizes in the plurality of successive frames;
identifying the largest coding block sizes that contain pixels having sufficiently similar depth values; and
selecting coding modes for block-based encoding of the coding blocks having, at minimum, the largest identified coding block sizes.

2. The method according to claim 1, further comprising:
dividing the frames into respective pluralities of coding blocks, wherein the depth values of the pixels are generated during a three-dimensional graphical rendering of the digital video stream, wherein dividing the frames further comprises, for each of the frames, dividing the frames into coding blocks of multiple sizes, and wherein identifying the largest coding blocks that contain pixels having substantially similar depth values further comprises:
pre-pruning selected ones of the multiple-sized coding blocks based upon the depth values of the multiple-sized coding blocks prior to the step of selecting coding modes.

3. The method according to claim 2, wherein the multiple sizes include a first size, a second size, and a third size, wherein the second size is one-quarter of the first size and the third size is one-quarter of the second size, wherein blocks having the second size are contained within blocks having the first size and wherein blocks having the third size are contained within blocks having the second size, and wherein pre-pruning the coding modes further comprises:
for each of the first-sized blocks,
comparing depth values of four blocks having the third size within each of the blocks having the second size; and
in response to the depth values being substantially similar in four of the third-sized blocks, removing block sizes smaller than the second size from a candidate set of coding blocks to be encoded.

4. The method according to claim 3, further comprising:
for each of the first-sized blocks,
comparing depth values of the blocks having the second size by comparing depth values of a first set of two horizontally adjacent blocks with each other and comparing depth values of a second set of two horizontally adjacent blocks with each other;
determining whether a difference between the depth values of the blocks in the first set falls below a predetermined level;
in response to the difference falling below the predetermined level, removing the blocks in the first set from the candidate set;
determining whether a difference between the depth values of the is blocks in the second set falls below the predetermined level; and
in response to the difference falling below the predetermined level, removing the blocks in the second set from the candidate set.

5. The method according to claim 4, further comprising:
for each of the first-sized blocks,
comparing depth values of the blocks having the second size by comparing depth values of a third set of two vertically adjacent blocks with each other and comparing depth values of a fourth set of two vertically adjacent blocks with each other;
determining whether a difference between the depth values of the blocks in the third set falls below a predetermined level;
in response to the difference falling below the predetermined level, removing the blocks in the third set from the candidate set;
determining whether a difference between the depth values of the blocks in the fourth set falls below the predetermined level; and
in response to the difference falling below the predetermined level, removing the blocks in the fourth set from the candidate set.

6. The method according to claim 5, further comprising:
for each of the first-sized blocks,
comparing the depth values of two horizontally adjacent blocks with the depth values of the other two horizontally adjacent blocks; and
in response to the two horizontally adjacent blocks being substantially similar to the other two horizontally adjacent blocks, removing each of the two horizontally adjacent blocks and the other two horizontally adjacent blocks from the candidate set of coding blocks.

7. The method according to claim 6, further comprising:
for each of the first-sized blocks,
comparing the depth values of two vertically adjacent blocks with the depth values of the other two vertically adjacent blocks; and
in response to the two vertically adjacent blocks being substantially similar to the other two vertically adjacent blocks, removing each of the two vertically adjacent blocks and the other two vertically adjacent blocks from the candidate set of coding blocks.

8. The method according to claim 1, wherein identifying the largest coding block sizes that contain pixels having substantially similar depth values further comprises identifying the largest coding block sizes by determining deviation values in similarity among the coding blocks, determining whether the deviation values exceed a predefined level, and removing those coding blocks having deviation values exceeding the predefined level from a candidate set of coding blocks to be encoded.

9. The method according to claim 1, wherein identifying the largest coding block sizes that contain pixels having sufficiently similar depth values further comprises using a similarity function to identify whether the depth values in the coding blocks are sufficiently similar.

10. The method according to claim 9, further comprising:
identifying maximum and minimum values of the normalized quantized depth values of the coding blocks; and
applying one of an absolute value and a relative value metric using the maximum and minimum values of the normalized quantized depth values of the coding blocks to define the similarity function.

11. The method according to claim 9, further comprising:
converting the normalized quantized depth values of the coding blocks to true depth values;
computing a sum of the true depth values; and
determining a largest difference in sums between any two coding blocks using an absolute value metric, wherein the similarity function is the largest difference in the sums.

12. The method according to claim 9, further comprising:
converting the normalized quantized depth values of the coding blocks to true depth values;
applying a Sobel operator to each pixel in the coding blocks in the depth domain to identify gradients of each of the pixels; and
wherein the similarity function is defined as a number of pixels with gradients greater than a pre-set gradient threshold.

13. The method according to claim 1, wherein selecting coding modes for block-based encoding of the coding blocks further comprises:
setting rate-distortion costs of the identified largest coding block sizes to infinity;
executing a coding mode selection operation on the coding blocks having, at minimum, the identified largest coding block sizes with the rate-distortion costs of the coding blocks having, at minimum, the identified largest coding block sizes to infinity.

14. A video encoder comprising:
at least one of hardware and software configured to receive a plurality of successive frames and depth values of pixels contained in multiple-sized coding blocks of the plurality of successive frames, to identify the largest coding block sizes that contain pixels having sufficiently similar depth values, wherein the coding blocks are determined to be sufficiently similar when deviation values of the coding blocks fall below a predefined level, and to select coding modes for block-based encoding of the coding blocks having, at minimum, the largest identified coding block sizes.

15. The video encoder according to claim 14, wherein the at least one of hardware and software is configured to sequentially pre-prune the coding blocks from the smallest coding block sizes to the largest coding block sizes according to deviation values in the similarities of the depth values of the respectively sized coding blocks to thereby identify the largest coding block sizes.

16. The video encoder according to claim 14, wherein the at least one of hardware and software is configured to use a similarity function to identify whether the depth values in the coding blocks are sufficiently similar.

17. The video encoder according to claim 14, wherein the at least one of hardware and software is configured to set rate-distortion costs of the identified largest coding blocks to infinity and to execute a coding mode selection operation on the coding blocks having, at minimum, the identified largest coding block sizes with the rate-distortion costs of the identified largest coding block sizes set to infinity to thereby select the coding modes for block-based encoding of the coding blocks having, at minimum, the largest identified coding block sizes.

18. The video encoder according to claim 14, wherein the at least one of hardware and software is further configured to encode the coding blocks through use of the selected coding modes.

19. A computer readable storage medium on which is embedded one or more computer programs, said one or more computer programs implementing a method of selecting coding modes for block-based encoding of a digital video stream, said digital video stream being composed of a plurality of successive frames, said one or more computer programs comprising computer readable code for:
obtaining depth values of pixels contained in coding blocks having multiple sizes in the plurality of successive frames;
identifying the largest coding block sizes that contain pixels having sufficiently similar depth values through implementation of a pre-pruning operation on the multiple-sized coding blocks; and
selecting coding modes for block-based encoding of the coding blocks having, at minimum, the largest identified coding block sizes.

20. The computer readable storage medium according to claim 19, said one or more computer programs further comprising computer readable code for:
implementing a similarity function on the depth values of the pixels in the multiple-sized coding blocks to identify the largest coding block sizes that contain pixels having sufficiently similar depth values.
